(19) United States
(12) Patent Application Publication
(10) Pub. No.: US 2025/0187084 A1
(43) Pub. Date: Jun. 12, 2025

(54) Two-Piece Drill Bit with Bonded Interface

(71) Applicant: Milwaukee Electric Tool Corporation, Brookfield, WI (US)

(72) Inventors: Hunter S. Karlen, Milwaukee, WI (US); Travis J. DuMez, Port Washington, WI (US)

(21) Appl. No.: 18/927,501

(22) Filed: Oct. 25, 2024

Related U.S. Application Data
(60) Provisional application No. 63/571,798, filed on Mar. 29, 2024.
(60) Provisional application No. 63/607,838, filed on Dec. 8, 2023.

(51) Int. Cl. B23B 51/00

(52) U.S. Cl. CPC B23B 51/0002

(57) ABSTRACT

A drill bit is provided having a tip segment, a shaft, and an interface feature. The tip segment includes a cutting end, an attachment end, and a body. The attachment end defines an attachment surface facing in a direction away from the cutting end. A cross-sectional area perpendicular to the central axis is defined by an outer perimeter of the body. The shaft includes a first end coupled to the attachment end. The interface feature is located on the attachment surface and positioned between the attachment end and the first end. An outer surface of the interface feature and the attachment surface define an interface surface. The interface surface has a surface area greater than the cross-sectional area of the tip segment. In various embodiments, the interface feature includes at least one protrusion and/or at least one recess.

### CROSS-REFERENCE TO RELATED PATENT APPLICATIONS

The present application claims the benefit of and priority to U.S. Provisional Application No. 63/571,798, filed Mar. 29, 2024, and U.S. Provisional Application No. 63/607,838, filed Dec. 8, 2023, which are incorporated herein by reference in their entireties.

### BACKGROUND OF THE INVENTION

The present invention relates generally to the field of tools. The present invention relates specifically to a two-piece drill bit where the two pieces are coupled together through a joining process such as welding or brazing.

### SUMMARY OF THE INVENTION

One embodiment of the invention relates to a drill bit including a central axis, a tip segment, a shaft, and an interface feature. The tip segment is centered on a extends along the central axis. The tip segment includes a cutting end configured to interface with a workpiece, an attachment end located opposite the cutting end along the central axis, and a body extending between the cutting end and the attachment end. The attachment end defines an attachment surface facing in a direction away from the cutting end along the central axis. The tip segment also includes a cross-sectional area perpendicular to the central axis defined by an outer perimeter of the body. The shaft extends along the central axis and is aligned with the tip segment. The shaft includes a first end coupled to the attachment end of the tip segment and a second end opposite the first end along the central axis. The second end is configured to be removably coupled to a rotary tool. The interface feature is located on the attachment surface and positioned between the attachment end of the tip segment and the first end of the shaft. The interface feature includes an outer surface facing the first end of the shaft. The attachment surface of the tip segment and the outer surface of the interface feature define an interface surface. The interface surface has a surface area greater than the cross-sectional area of the tip segment.

Another embodiment of the invention relates to a drill bit comprising a shaft centered along a central axis, a tip segment centered on and extending along the central axis, and an interface feature. The shaft includes a first end and a second end opposite the first end along the central axis. The second end is configured to removably couple to a rotary tool. The tip segment includes a cutting end configured to engage a workpiece, an attachment end located opposite the cutting end along the central axis, and a body extending between the cutting end and the attachment end. The attachment end defines an attachment surface facing the first end of the shaft. The tip segment also includes a cross-sectional area perpendicular to the central axis defined by an outer perimeter of the body. The interface feature is formed along the attachment surface and includes an outer surface spaced a distance from the attachment surface of the tip segment. The attachment surface and the outer surface define an interface surface. The interface surface has a surface area greater than the cross-sectional area of the tip segment.

Another embodiment of the invention relates to a method of forming a drill bit. The method includes providing a tip segment made from a first material. The tip segment includes a cutting end configured to interface with a workpiece, an attachment end opposite the cutting end and defining an attachment surface facing away from the cutting end, and an interface feature located on the attachment surface. The method also includes aligning the tip segment with a shaft made from a second material different from the first material such that the interface feature is positioned between the attachment end of the tip segment and a first end of the shaft. The method also includes placing an inner layer made from a third material different from the first material and the second material between the tip segment and the shaft, and heating the tip segment, the shaft, and the inner layer to a specific temperature to join the tip segment, the shaft, and the inner layer together.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a drill bit, according to an exemplary embodiment;

FIG. 2 is an exploded view of the drill bit of FIG. 1 with a graphical representation of the energy used during a joining process, according to an exemplary embodiment;

FIG. 3 is a bottom perspective view of a tip segment for a drill bit, according to an exemplary embodiment;

FIG. 4 is a bottom perspective view of a tip segment of a drill bit, according to an exemplary embodiment;

FIG. 5 is a bottom perspective view of a tip segment of a drill bit, according to an exemplary embodiment;

FIG. 6 is a bottom perspective view of a tip segment of a drill bit, according to an exemplary embodiment;

FIG. 7 is a bottom perspective view of a tip segment of a drill bit, according to an exemplary embodiment;

FIG. 8 is a bottom perspective view of a tip segment of a drill bit, according to an exemplary embodiment;

FIG. 9 is a perspective view of an induction bonding machine, according to an exemplary embodiment;

FIG. 10 shows a drill bit during a joining process in the induction bonding machine of FIG. 9, according to an exemplary embodiment;

FIG. 11 is a bottom perspective view of a tip segment of a drill bit, according to an exemplary embodiment;

FIG. 12 is a bottom perspective view of a tip segment of a drill bit, according to an exemplary embodiment;

FIG. 13 is a detail view of the inner layer coupled to the tip segment of FIG. 12, according to an exemplary embodiment;

FIG. 14 is a bottom perspective view of a tip segment of a drill bit, according to an exemplary embodiment; and

FIG. 15 is a flow diagram of a method of manufacturing a drill bit, such as the drill bit of FIG. 1, according to an exemplary embodiment.

### DETAILED DESCRIPTION

Referring generally to the figures, various embodiments of a drill bit are shown. Specifically, a two-piece drill bit is shown having a tip segment and a body segment. Applicant believes that the drill bits discussed herein provide for various advantages over typical two-piece drill bits.

Various drill bits discussed herein include at least one interface feature (e.g., a protrusion and/or recess) located at the interface between the tip segment and the shaft that increases the bonding surface area available to couple the tip segment to the shaft. Specifically, the drill bits discussed herein have at least one protrusion extending between the tip segment and the body segment and/or at least one recessed section positioned between the tip segment and body segment. It is believed that providing protrusions and/or recesses creates a stronger bond between the tip segment and body segment during the joining process (e.g., welding, brazing, etc.) because the protrusions and/or recesses increases the surface area of the interface of the tip segment and the body segment when the tip segment and body segment are coupled together. Applicant believes that this may allow for a thicker tip segment to be attached to the body segment.

Additionally, it is believed that the protrusions and/or recesses assist in changing heating patterns, setting specific joint gap heights, limiting the surface contact between the tip segment and the body segment, and reducing the effects of misalignment between the tip segment and the body segment. Applicant believes that the protrusions and/or recesses are useful for several joining methods including resistance welding, resistance brazing, induction welding, and induction brazing, among others. Further, Applicant has found that the protrusions and/or recesses are helpful in joining a carbide tip segment to a steel body segment for larger diameter drill bits (i.e., drill bits which have a ¾″ diameter or greater), such as drill bits for a concrete drill.

In addition, various drill bits discussed wherein the tip segment and the body segment are joined through a joining process (e.g., welding, brazing, etc.) where the only force applied by a bonding machine to the tip segment and the body segment come from the downward force of the tip segment when placed on top of the body segment, and vice versa (i.e., the body segment is placed on top of the tip segment). Specifically, the machine used to join the drill bit (e.g., an induction bonding machine) does not exert any additional force on the tip segment or the body segment. This process is believed to provide a strong bond between the tip segment and body segment, as well as reduce the effects of misalignment between the tip segment and the body segment.

In addition, various drill bits discussed herein include an intermediary. In various embodiments, the intermediary includes an inner layer positioned between the tip segment and the body segment. In certain embodiments, the inner layer is made of a copper-nickel alloy, such as the copper-nickel alloy sold under the trademark Constantan®. Applicant believes that the use of a copper-nickel alloy in the inner layer creates a stronger bond between the tip segment and body segment during the joining process (e.g., welding, brazing, etc.), while reducing the melting point required to join the tip segment and body segment. In certain embodiments, the inner layer is made from a metal mesh (e.g., a nickel wire mesh). Applicant believes that the use of a metal mesh to form the inner layer creates a stronger bond between the tip segment and body segment because the mesh structure increases the surface area of the inner layer. Additionally, it is believed that a metal mesh increases the wetting ability of inner layer, increases the diffusion of materials into the chemical composition of the interface between the tip segment and the body segment, and helps with setting specific joint gap heights.

In addition, in certain embodiments the intermediary includes one piece of metal wire (e.g., rounded nickel wire) located at the interface between the tip segment and the body segment. It is believed that providing metal wire at the interface creates a stronger bond between the tip segment and body segment during the joining process (e.g., welding, brazing, etc.), and assists in setting specific joint gap heights.

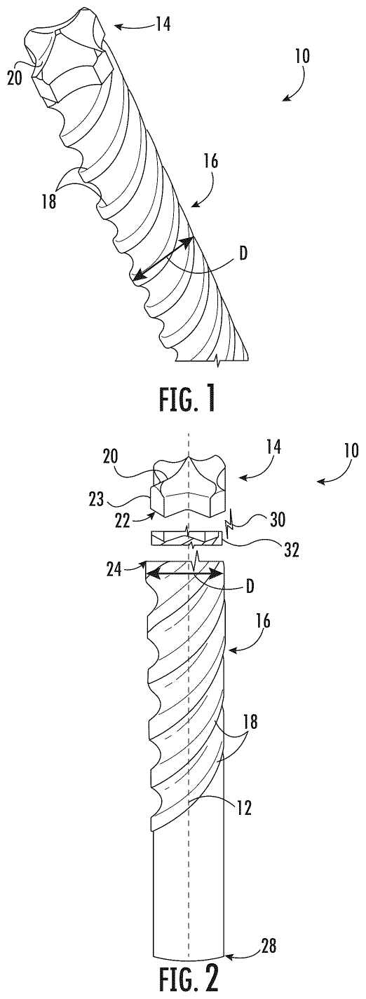

Referring to FIGS. 1 and 2, a drill bit 10 is shown and described. Drill bit 10 is configured to removably couple to a rotary tool, such as a drill, in order to cut a workpiece. Drill bit 10 extends along a central axis 12 and includes a tip segment 14 and a body segment or shaft 16. Drill bit 10 has a diameter, D. In some embodiments, D is greater than or equal to ¾ inches.

Tip segment 14 is centered on and extends along central axis 12. Tip segment 14 includes a cutting end 20 and an attachment end 22 located opposite from the cutting end 20 along central axis 12. A tip body 23 extends between cutting end 20 and attachment end 22. Cutting end 20 is configured to engage a workpiece to drill a hole.

Shaft 16 includes a plurality of flutes 18, which assist drill bit 10 during cutting of a workpiece. Shaft 16 is centered on and extends along central axis 12. In this way, shaft 16 and tip segment 14 are aligned along central axis 12 and are co-linear with each other. Specifically, a center portion of tip segment 14 and a center portion of shaft 16 are co-linear.

Shaft 16 includes a first end 24 and a second end 28. Second end 28 is located opposite from first end 24 along central axis 12 and is configured to removably couple to a rotary tool. First end 24 is located adjacent to attachment end 22. First end 24 is coupled to attachment end 22.

Tip segment 14 is made of a first material and shaft 16 is made of a second material. In a certain embodiment, the first material has a greater hardness than the second material, and the first material has a greater heat resistance than the second material. In another certain embodiment, the first material is carbide or a carbide alloy, and the second material is steel. In this way, a carbide tip segment may allow for drill bit 10 to withstand higher temperatures and cut workpieces made from harder materials.

As shown in FIG. 2, tip segment 14 and shaft 16 are fixedly coupled together through a bonding or joining process (e.g., brazing, welding, etc.) utilizing energy 30, such as heat and/or pressure, to form drill bit 10. Specifically, attachment end 22 of tip segment 14 and first end 24 of shaft 16 are joined together with a consumable or filler 32 during the joining process. Thus, an interface is defined between the attachment end 22 and first end 24. In certain embodiments, filler 32 is positioned between first end 24 and attachment end 22 such that first end 24 and attachment end 22 do not contact each other. In other embodiments, at least a portion of first end 24 and a portion of attachment end 22 are in direct contact with each other. In a certain embodiment, filler 32 is made from a third material different from the first material of tip segment 14 and the second material of shaft 16.

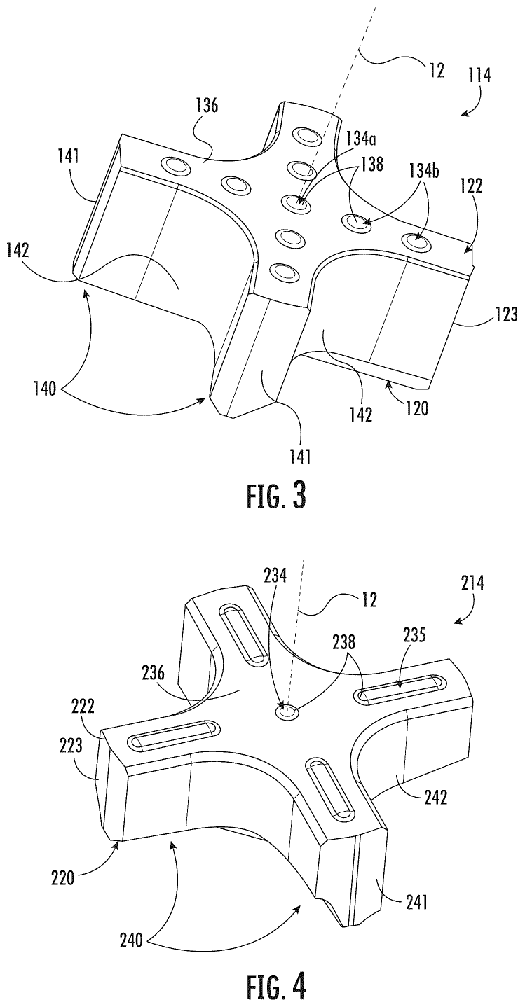

Referring to FIGS. 3-8, details of interface designs that may be utilized with a drill bit, such as drill bit 10, discussed above, are shown. In such drill bit designs, drill bit 10 includes interface features, such as protrusions extending from the attachment end 22 of tip segment 14 and/or recesses extending towards cutting end 20 of tip segment 14. In various embodiments, drill bit 10 may include protrusions extending from first end 24 of shaft 16 and/or may include recesses extending towards second end 28 of shaft 16. It should be understood that FIGS. 1 and 2 detail various components of drill bit 10, and details of interface features (i.e., protrusions and/or recesses) that may be utilized with drill bit 10 are shown in FIGS. 3-8.

Referring to FIG. 3, a tip segment 114 is shown and described. Tip segment 114 is substantially the same as tip segment 14 except for the differences described herein. Specifically, tip segment 114 includes protrusions 134 which increase the surface area of the interface between tip segment 114 and a body segment, such as shaft 16. As shown, protrusions 134 extend from attachment end 122 of tip segment 114. In other embodiments, tip segment 114 may include recesses which extend towards cutting end 120 of tip segment 114.

As shown in FIG. 3, tip segment 114 is centered on and extends along central axis 12. Tip segment 114 includes a plurality of protrusions 134. Protrusions 134 extend in a direction away from attachment end 122 and away from cutting end 120. Specifically, protrusions 134 are coupled to an attachment surface, shown as top surface 136, of attachment end 122. Protrusions 134 extend a first distance away from cutting end 120, and attachment end 122 extends a second distance away from the cutting end 120 such that the first distance is greater than the second distance. This allows for protrusions 134 to extend a distance past top surface 136 of attachment end 122. In certain embodiments, protrusions 134 and tip segment 114 are formed from a single, continuous, and contiguous material such that tip segment 114 and protrusions 134 are unitary.

The distance between top surface 136 and an outer surface 138 of protrusions 134 defines a protrusion height. Further, tip segment 114 has a height defined by the distance from cutting end 120 to attachment end 122.

Top surface 136 of attachment end 122 and outer surface 138 of protrusions 134 define an interface surface. Interface surface is the surface of tip segment 114 which at least partially defines the interface between tip segment 114 and shaft 16 when tip segment 114 and a body segment, like shaft 16, are joined together.

In other embodiments, tip segment 114 includes recesses or recessed sections. Recessed sections extend past top surface 136 and into tip body 123 towards cutting end 120. Recessed sections define a recess surface. In such embodiments, interface surface is defined by top surface 136 and the recess surface.

In certain embodiments, interface surface has a surface area that is greater than the cross-sectional area of tip segment 114 defined by the outer perimeter of tip segment 114. In other embodiments, the surface area of the interface surface is greater than the surface area of top surface 136.

During the joining process, it is believed that protrusions 134 and/or recesses assist in changing heating patterns, setting specific joint gap heights, limiting the surface contact between tip segment 114 and shaft 16, and aligning tip segment 114 and shaft 16. Protrusions 134 and/or recesses provide additional surface area for filler 32 to adhere to, which is believed to create a stronger bond between tip segment 114 and shaft 16.

In certain embodiments, outer surface 138 of protrusions 134 abuts first end 24 of shaft 16 and filler 32 fills the gaps between protrusions 134. In other embodiments, protrusions 134 do not contact first end 24 such that filler 32 is positioned between outer surface 138 of protrusions 134 and first end 24.

As shown in FIG. 3, tip body 123 is a three-dimensional cross shape. Specifically, tip body 123 includes four arms 140 that are evenly spaced from each other around central axis 12. Specifically, arms 140 are spaced orthogonal to each other. Each arm 140 includes an arm sidewall 141 located a furthest distance along arm 140 from central axis 12. Arms 140 are connected to each other by curved sidewalls 142 which extend between each arm 140. Curved sidewalls 142 are curved in a direction away from central axis 12 such that a center portion of each curved sidewall 142 is located closer to central axis 12 than arm sidewalls 141. That is, curved sidewalls 142 are convex with respect to central axis 12.

Plurality of protrusions 134 extend from top surface 136. As shown, tip segment 114 includes nine protrusions 134 extending from attachment end 122. Protrusions 134 are substantially the same size and shape as each other. As shown, each protrusion 134 has a rounded shape. Each outer surface 138 of protrusions 134 curves away from top surface 136. More specifically, protrusions 134 are hemisphere shaped.

Protrusions 134 are spaced from each other along top surface 136. Specifically, protrusion 134a is centered on and extends along central axis 12. In this way, protrusion 134a is centered on tip segment 114. Protrusions 134b are spaced away from the central protrusion 134a and are located along arms 140. As shown, each arm 140 includes two protrusions 134b. Protrusions 134b are aligned with central protrusion 134a. Protrusions 134b are centered along arms 140 and are spaced away from sidewalls 141, 142.

Referring to FIG. 4, a tip segment 214 is shown according to an exemplary embodiment. Tip segment 214 is substantially the same as tip segments 14 and 114 except for the differences discussed herein. Specifically, tip segment 214 includes rounded protrusions 234 and elongate protrusions 235. In other embodiments, tip segment 214 includes rounded recesses and elongate recesses which extend towards cutting end 220 of tip segment 214.

Tip body 223, like tip segment 114, is a three-dimensional cross shape with arms 240, arm sidewalls 241, and curved sidewalls 242. Tip segment 214 includes plurality of protrusions 234, 235 which extend from top surface 236 of attachment end 222. Each protrusion 234, 235 extends a distance away from top surface 236 that defines a protrusion height. Protrusions 234, 235 are spaced from each other along top surface 236. Together, top surface 236 and outer surfaces 238 of protrusions 234, 235 define an interface surface. In certain embodiments, protrusions 234, 235 and tip segment 214 are formed from a single, continuous, and contiguous material such that tip segment 214 and protrusions 234, 235 are unitary.

In other embodiments, tip segment 214 includes recesses. Recesses extend past top surface 236 and into tip body 223 towards cutting end 220. In such embodiments, interface surface is defined by top surface 236 and a recess surface defined by the recess.

Interface surface is the surface of tip segment 214 which helps define the interface between tip segment 214 and a body segment, like shaft 16, when tip segment 214 and shaft 16 are joined together through welding, brazing, etc. In certain embodiments, interface surface has a surface area which is greater than the cross-sectional area of tip segment 214 defined by the outer perimeter of tip segment 214.

Specifically, tip segment 214 includes a rounded protrusion 234 and four elongate protrusions 235. Protrusions 234, 235 each have a curved outer surface 238 which bends away from top surface 236. Rounded protrusion 234 is centered on tip segment 214 and on central axis 12. Rounded protrusion 234 has a rounded surface. In a certain embodiment, rounded protrusion 234 is hemisphere shaped.

Elongate protrusions 235 are radially spaced around rounded protrusion 234 and central axis 12. Each elongate protrusion 235 is evenly space from each other around rounded protrusion 234. Specifically, an elongate protrusion 235 is located on each arm 240. Protrusions 235 extend along arms 240 between central axis 12 and arm sidewall 241. As shown, elongate protrusions 235 are obround shaped or stadium shape. So, elongate protrusions 235 have two parallel sides connected by two rounded ends. A center of each elongate protrusion 235 is aligned with rounded protrusion 234. Elongate protrusions 235 are centered along arms 240 and are spaced away from sidewalls 241, 242.

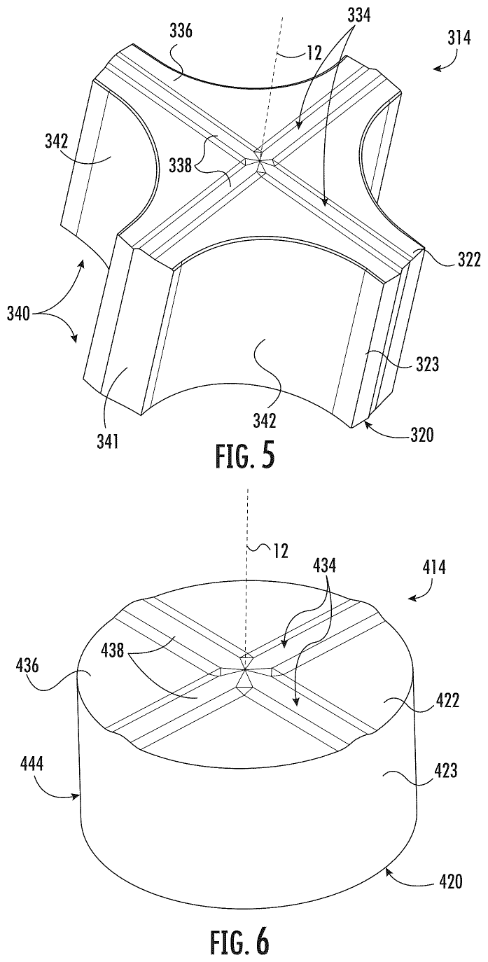

Referring to FIG. 5, a tip segment 314 is shown according to an exemplary embodiment. Tip segment 314 is substantially the same as tip segments 14, 114, and 214 except for the differences discussed herein. Specifically, tip segment 314 includes two protrusions 334 which intersect with each other and extend across the length of tip segment 314 between sidewalls. In other embodiments, tip segment 314 includes two recesses which extend across the length of tip segment 314.

Tip segment 314, like tip segment 114 and 214, has a tip body 323 that is a three-dimensional cross shape. Tip segment 314 has four arms 340, arm sidewalls 341, and curved sidewalls 342. Tip segment 314 includes two protrusions 334 which extend away from top surface 336 of tip segment 314. In certain embodiments, protrusions 334 and tip segment 314 are formed from a single, continuous, and contiguous material such that tip segment 314 and protrusions 334 are unitary.

The height of each protrusion 334 is defined by the distance that protrusion 334 extends away from top surface 336. Protrusions 334 include a curved outer surface 338 which bends away from top surface 336. Top surface 336 and outer surfaces 338 define an interface surface.

In other embodiments, tip segment 314 includes recesses. Recesses extend past top surface 336 and into tip body 323 towards cutting end 320. In such embodiments, interface surface is defined by top surface 336 and a recess surface defined by the recess.

Interface surface is the surface of tip segment 314 which at least partially defines the interface between tip segment 314 and a body segment, like shaft 16, when tip segment 314 and shaft 16, are joined together. In certain embodiments, interface surface has a surface area which is greater than the cross-sectional area of tip segment 314 defined by the outer perimeter of tip segment 314.

Specifically, tip segment 314 includes two protrusions 334. Each protrusion 334 extends between two arm sidewalls 341. That is, each protrusion extends across the length of tip segment 314 from a first arm sidewall 341 to a second arm sidewall 341. Each end of protrusions 334 are substantially flush with sidewalls 341 such that protrusions 334 do not extend past sidewalls 341. So, protrusions 334 have a length equal to or less than the length of tip segment 314. Each protrusion 334 is centered along arms 340 and intersects central axis 12. As shown, protrusions 334 are perpendicular to central axis 12. Additionally, the two protrusions 334 intersect with each other and are perpendicular to each other.

Referring to FIG. 6, a tip segment 414 for a drill bit, like drill bit 10, is shown according to an exemplary embodiment. Tip segment 414 is substantially the same as tip segments 14, 114, 214, and 314, except for the differences discussed herein. Specifically, tip segment 414 is a cylinder shape and includes two protrusions 434 which intersect with each other and extend across the diameter of tip segment 414. In other embodiments, tip segment 414 includes two recesses which intersect with each other and extend across the diameter of tip segment 414.

As shown, tip body 423 is cylinder shaped, and has a top surface 436 that is circular. Tip body 423 has a rounded outer wall 444. Outer wall 444 defines the diameter of tip body 423. Tip segment 414 has a height defined by the distance between attachment end 422 and cutting end 420.

Tip segment 414 includes at least one protrusion 434. As shown, tip segment 414 includes two protrusions 434 that extend from top surface 436 of attachment end 422. The height of each protrusion 434 is defined by the distance protrusion 434 extends from top surface. In certain embodiments, protrusions 434 and tip segment 414 are formed from a single, continuous, and contiguous material such that tip segment 414 and protrusions 434 are unitary.

Protrusions 434 include a curved outer surface 438. Together, top surface 436 and outer surface 438 define an interface surface. In other embodiments, tip segment 414 includes recesses. Recesses extend past top surface 436 and into tip body 423 towards cutting end 420. In such embodiments, interface surface is defined by top surface 436 and a recess surface defined by the recess.

The interface surface is the surface of tip segment 414 which at least partially defined the interface between tip segment 414 and a body segment, like shaft 16, when tip segment 414 and shaft 16 are joined together. In certain embodiments, interface surface has a surface area that is greater than the cross-sectional are of tip segment 414 defined by the outer perimeter of tip segment 414.

Similar to tip segment 314, each protrusion 434 extends across tip segment 414. Protrusions 434 extend between a first portion of outer wall 444 to a second portion of outer wall 444. That is, protrusion extend a length across tip body 423 equal to or less than the diameter of tip body 423. Each end of protrusions 434 is substantially flush with outer wall 444 such that protrusions 434 do not extend past outer wall 444. As shown, each protrusion 434 intersects and is perpendicular to central axis 12. Additionally, protrusions 434 intersect and are perpendicular with each other.

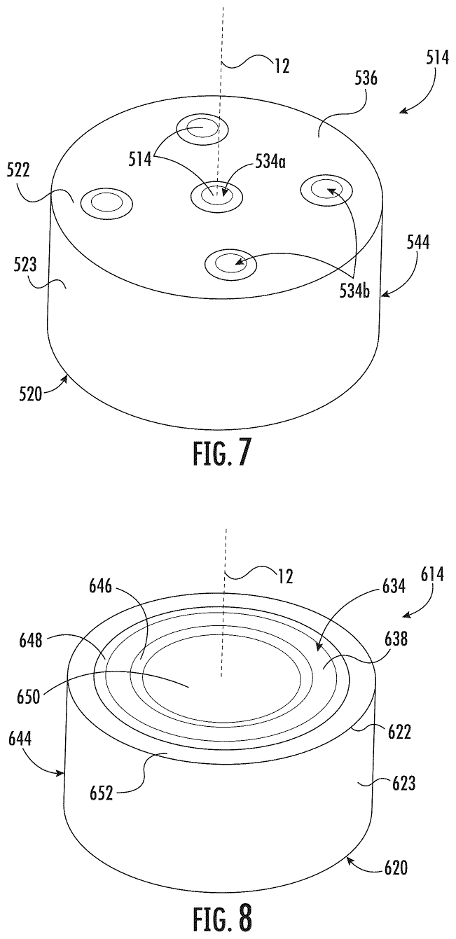

Referring to FIG. 7, a tip segment 514 is shown according to an exemplary embodiment. Tip segment 514 is substantially the same as tip segments 14, 114, 214, 314, and 414 except for the differences discussed herein. Specifically, tip segment 514 is cylinder shaped and includes a plurality of rounded protrusions 534. In other embodiments, tip segment 514 includes recesses which extend towards cutting end 520 of tip segment 514.

Tip segment 514, like tip segment 414, includes a tip body 523 that is a cylinder shape with an outer wall 544. Tip segment 514 includes a plurality of protrusions 534 that extend from top surface 536 of attachment end 522 of tip segment 514. A protrusion height is defined by the distance that protrusions 534 extend away from top surface 536. In certain embodiments, protrusions 534 and tip segment 514 are formed from a single, continuous, and contiguous material such that tip segment 514 and protrusions 534 are unitary.

Each protrusion 534 has a curved outer surface 538. Outer surface 538 and bends away from top surface 536. Top surface 536 and outer surfaces 538 define an interface surface. In other embodiments, tip segment 514 includes recesses. Recesses extend past top surface 536 and into tip body 523 towards cutting end 520. In such embodiments, interface surface is defined by top surface 536 and a recess surface defined by the recess.

Interface surface is the surface of tip segment 514 which helps to define the interface between tip segment 514 and a body segment, like shaft 16, when tip segment 514 and shaft 16, are joined together through welding, brazing, etc. In some embodiments, interface surface has a surface area which is greater than the cross-sectional area of tip segment 514 defined by the outer perimeter of tip segment 514.

As shown in FIG. 7, tip segment 514 includes five protrusions 534. Protrusions 534 are spaced from each other along top surface 536. Protrusions 534 are substantially the same size and shape as each other. Specifically, each protrusion 534 has a rounded shape and a rounded outer surface 538. More specifically, protrusions 534 are hemisphere shaped.

Tip segment 514 has a central protrusion 534a which is centered on tip segment 514 and central axis 12. Tip segment 514 further includes protrusions 534b which are spaced away from central protrusion 534a and away from outer wall 544. Protrusions 534b are radially spaced from each other around central axis 12. Specifically, protrusions 534b are equally spaced from each other and are each located an equal distance away from central protrusion 534a.

Referring to FIG. 8, a tip segment 614 is shown according to an exemplary embodiment. Tip segment 614 is substantially the same as tip segments 14, 114, 214, 314, 414, and 514 except for the differences discussed herein. In particular, tip segment 614 includes a protrusion 634 which extends around the perimeter of tip segment 614. In other embodiments, tip segments 614 includes a recess which extends around the perimeter of tip segment 614.

Tip segment 614, like tip segment 414 and 514, includes a tip body 623 that is a cylinder shape with an outer wall 644. Tip segment 614 includes at least one protrusion 634. Protrusion 634 extends from attachment end 622 and more specifically from top surface 636. Protrusion 634 extends a distance from top surface 636 defining a protrusion height. In certain embodiments, protrusion 634 and tip segment 614 are formed from a single, continuous, and contiguous material such that tip segment 614 and protrusions 634 are unitary.

Protrusion 634 includes a curved outer surface 638 which bends away from top surface 636. Outer surface 638 and top surface 636, together, define an interface surface. In other embodiments, tip segment 614 includes recesses. Recesses extend past top surface 636 and into tip body 623 towards cutting end 620. In such embodiments, interface surface is defined by top surface 636 and a recess surface defined by the recess.

When tip segment 614 and a body segment, such as shaft 16, are joined together, interface surface is the surface of tip segment 614 which at least partially defines the interface between tip segment 614 and shaft 16. In certain embodiments, interface surface has a surface area which is greater than the cross-sectional area of tip segment 614 defined by the outer perimeter of tip segment 614.

As shown in FIG. 8, protrusion 634 extends around the perimeter of attachment end 622 of tip segment 614. Protrusion 634 is spaced from outer wall 644 of tip segment 614 and is spaced from central axis 12. Specifically, protrusion 634 is circular. Protrusion 634 has an inner edge 646 and an outer edge 648. Inner edge 646 and outer edge 648 are both circular and are concentric with each other. That is, protrusion 634 is centered around central axis 12, and inner edge 646 is located closer to central axis 12 than outer edge 648.

Additionally, protrusion 634 defines an inner portion 650 of top surface 636 located between inner edge 646, and protrusion defines an outer portion 652 of top surface 636 located between outer edge 648 and outer wall 644. That is, top surface 636 is divided by protrusion 634 into inner portion 650 and outer portion 652.

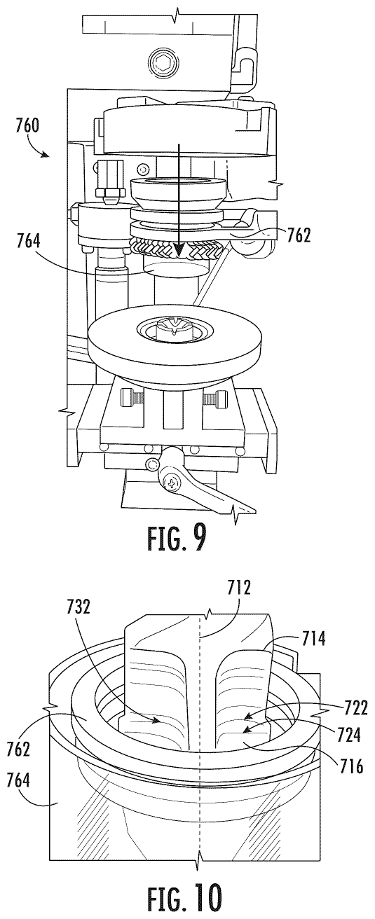

Referring generally to FIGS. 9 and 10, details of a joining method that may be utilized with drill bits, such as drill bit 10, are shown. Specifically, the only downward force applied during the joining method shown in FIGS. 9 and 10 is the downward force of the tip segment when placed on top of the body segment, or vice versa (i.e., the body segment is placed on top of the tip segment). It is believed that this method provides a strong bond between a tip segment and a body segment and may reduce the effects of misalignment between the tip segment and the body segment.

Referring to FIGS. 9 and 10, a bonding machine 760 for joining a tip segment 714 to a body segment or shaft 716, is shown and described. Specifically, bonding machine 760 is an induction bonding machine and includes a heating coil 762 and an insulation tube 764.

In order to join tip segment 714 to shaft 716, tip segment 714 and shaft 716 are centered and aligned along central axis 712 such that an attachment end 722 of tip segment 714 and a first end 724 of shaft 716 face each other. Then, tip segment 714 and shaft 716 are placed in bonding machine 760 such that attachment end 722 of tip segment 714 and first end 724 of shaft 716 are surrounded by heating coil 762 and insulation tube 764. In particular, bonding machine 760 does not apply a force to tip segment 714 or shaft 716. Rather, the only force applied by bonding machine 760 to tip segment 714 and shaft 716 is the downward force, or weight, of tip segment 714 when placed on top of shaft 716, and vice versa. As shown in FIG. 10, shaft 716 is placed above tip segment 714 and the weight of shaft 716 provides a downward force on tip segment 714. Attachment end 722 and first end 724 are then joined together with a consumable or filler 732 when heating coil 762 is heated to a specific temperature. Thus, tip segment 714 is joined to shaft 716, and a drill bit is formed.

In other embodiments, the method of FIGS. 9 and 10 can be utilized with any of the tip segments and/or body segments discussed herein.

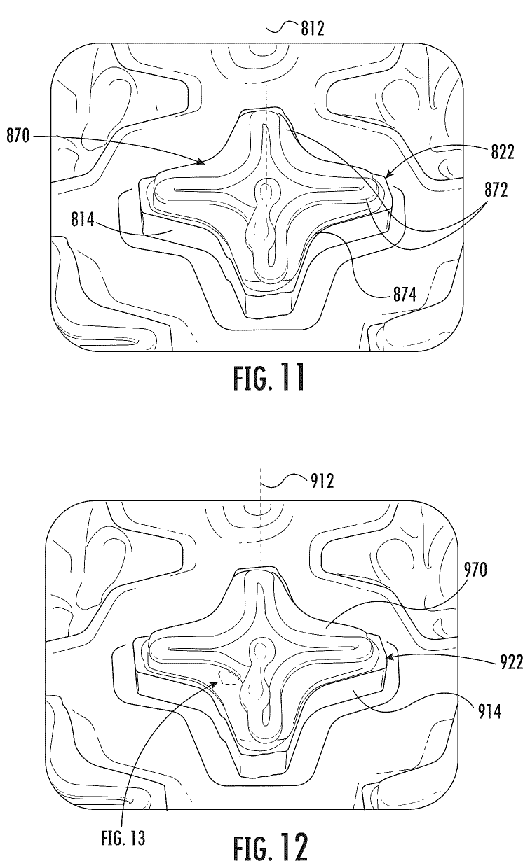

Referring generally to FIGS. 11-13, interface designs that may be utilized with a drill bit, such as drill bit 10, are shown and described. In such drill bit designs, drill bit 10 includes an intermediary, such as an inner layer. The inner layer is positioned between the tip segment 14 and the body segment 16. The inner layer may be coupled to the tip segment 14 and/or body segment 16. During the joining process (e.g., welding, brazing, etc.), the inner layer helps define the interface between tip segment 14 and the body segment 16. It should be understood that the inner layer designs may be utilized with any of the tip segments and/or body segments discussed herein.

Referring to FIG. 11, tip segment 814 is shown and described. Tip segment 814 is substantially the same as tip segments 14, 114, 214, 314, 414, 514, and 614 except for the differences described herein. Specifically, an inner layer 870 is coupled to attachment end 822 of tip segment 814. Inner layer 870 is coupled to attachment end 822 with a bonding paste. Inner layer 870 is shaped substantially the same as attachment end 822. That is, inner layer 870 includes four arms 872 that are evenly spaced from each other around central axis 812. Specifically, arms 872 are spaced orthogonal to each other. Arms 872 are connected to each other by curved sidewalls 874 which extend between each arm 872. Curved sidewalls 874 are curved in a direction away from central axis 812 such that curved sidewalls 874 are convex with respect to central axis 812. The height of inner layer 870 may be used to assist in setting the joint gap height of a drill bit.

In a certain embodiment, inner layer 870 is made of a copper-nickel alloy, and more specifically is made of a copper-nickel alloy with a greater percentage of copper than the percentage of nickel, such as the copper-nickel alloy sold under the trademark Constantan®. In a certain embodiment, the copper-nickel alloy is made from 45% nickel or less. In another certain embodiment, the copper-nickel alloy is made from 55% copper or more. It is believed that the use of a copper-nickel alloy for inner layer 870 creates a stronger bond between tip segment 814 and a body segment during the joining process (e.g., welding, brazing, etc.), while reducing the melting point required to join the tip segment and body segment. In a certain embodiment, inner layer 870 has a melting point below 1295° C., and more specifically a melting point between 1200° C. and 1295° C., and more specifically, a melting point of approximately 1210° C.

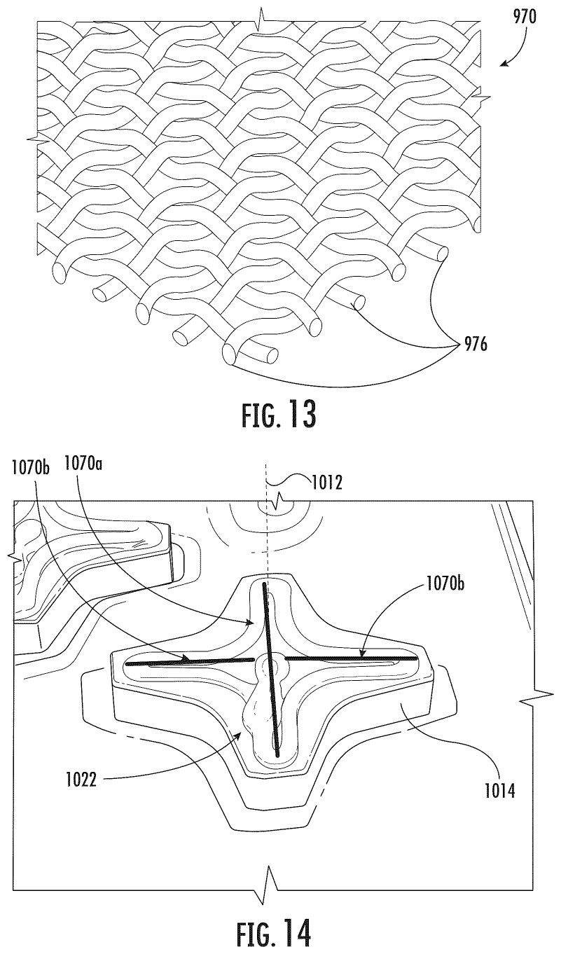

Referring to FIGS. 12 and 13, a tip segment 914 and inner layer 970 are shown and described. Tip segment 914 is substantially the same as tip segments 14, 114, 214, 314, 414, 514, 614, and 814, except for the differences discussed herein. Inner layer 970 is substantially the same inner layer 870 except for the differences discussed herein. Specifically, inner layer 870 is made from a metal mesh, and more specifically from a nickel wire mesh. Applicant believes that the use of a metal mesh to form inner layer 970 creates a stronger bond between the tip segment and body segment because the mesh structure increases the surface area of inner layer 970. Additionally, it is believed that a metal mesh increases the wetting ability of inner layer, increases the diffusion of materials into the chemical composition of the interface between the tip segment and the body segment, and helps with setting specific joint gap heights.

Referring to FIGS. 12 and 13, inner layer 970 is coupled to tip segment 914 and more specifically attachment end 922 of tip segment 914. As shown in FIG. 13, inner layer 970 includes a plurality of wire pieces 976. In a certain embodiment, wire pieces 976 are made from nickel or a nickel alloy. Wire pieces 976 each have alternating bends along its length. That is, the wire pieces 976 are crimped. Wire pieces 976 are secured together to create the metal mesh. The alternating bends in wire pieces 976 increase the surface area of inner layer 970. The height of inner layer 970 may be used to assist in setting the joint gap height of a drill bit.

Referring generally to FIG. 14, details of an interface design that may be utilized with a drill bit, such as drill bit 10, are shown. In such drill bit designs, drill bit 10 may include metal wire positioned between the tip segment 14 and the body segment 16. The metal wire may be coupled to tip segment 14 and/or body segment 16. During the joining process (e.g., welding, brazing, etc.), the metal wire helps define the interface between tip segment 14 and body segment 16. It is believed that providing metal wire at the interface creates a stronger bond between tip segment 14 and body segment 16 during the joining process (e.g., welding, brazing, etc.), and assists in setting specific joint gap heights.

Referring to FIG. 14, a tip segment 1014 is shown and described. Tip segment 1014 is substantially the same as tip segments 14, 114, 214, 314, 414, 514, 614, 814, and 914 except for the differences discussed herein. Specifically, a plurality of wire pieces 1070 are coupled to tip segment 1014. As shown, three wire pieces 1070 are positioned along attachment end 1022 of tip segment 1014 in a plus-sign, or X, pattern. One wire piece 1070a is centered on tip segment 1014 and intersects central axis 1012. Wire piece 1070a is substantially perpendicular to central axis. The other two wire pieces 1070b are positioned on opposite sides of wire piece 1070a and do not intersect with central axis 1012. Wire pieces 1070b are substantially perpendicular to central axis 1012 and wire piece 1070a.

In a certain embodiment, wire pieces 1070 are made from rounded nickel wire. The diameter of wire pieces 1070 may be used to assist in setting the joint gap height of a drill bit.

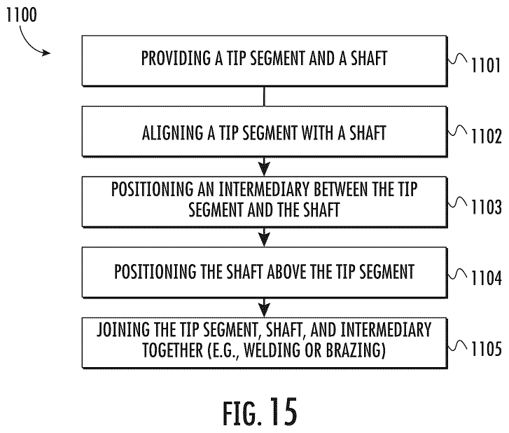

Referring to FIG. 15, a flow diagram of a method 1100 for producing a drill bit, such as drill bit 10, is provided. In step 1101, a tip segment, such as tip segments 14, 114, 214, 314, 414, 514, 614, 814, 914, and 1014, and a shaft, such as shafts 16 and 716, are provided. In step 1102, the tip segment is aligned with a shaft such that at least one protrusion and/or at least one recessed section is positioned between the tip segment and body segment. In a certain embodiment, the tip segment comprises at least one protrusion and, in step 1102, the at least one protrusion extends towards a first end of the shaft. In step 1103, an intermediary is placed between the tip segment and the shaft. The intermediary may be an inner layer, such as inner layers 870 and 970, a consumable or filler, such as fillers 32 and 732, or wire pieces, such as wire pieces 1070. In step 1104, the shaft is positioned above the tip segment such that the shaft provides a downward force on the tip segment. In step 1105, the tip segment, shaft, and intermediary are joined together through a joining process (e.g., welding or brazing). During the joining process, the tip segment, the shaft, and the intermediary are heated to a specific temperature.

### Performance Test Data

In performance testing, Applicant found that the addition of protrusions reduced the risk of weld or braze failures. The control group for the performance testing were five drill bits that had a 1.5″ tip segment and no protrusions. Out of the five drill bits in the control group, there were three braze failures which resulted in an average performance rate of 66.2. The first group with protrusions, which consisted of five drill bits with a 1.5″ weld, had no failures and obtained an average performance rate of 100. The second group with protrusions had of five 1.5″ welded drill bits. The second group had an average performance rate of 81.4. The third and final group with protrusions consisted of five drill bits with a 1.5″ braze. The third group had an average performance rate of 91.8.

In additional performance testing, Applicant found that the other drill bits discussed herein reduced the risk of weld or braze failures. The control group for this performance testing was five drill bits with a 1″ tip segment and 13″ shaft. The average performance rate of the control group was 62.8. The test group for drill bits produced using the method of production with downward force only coming from the weight of the tip and/or shaft, which consisted of five drill bits, obtained an average performance rate of 90.2. The test group for drill bits with an inner layer made from the copper-nickel alloy Constantan®, which included five drill bits with a 0.1 mm inner layer, had an average performance rate of 84.6. The test group for drill bits with metal wire pieces, which included five drill bits with nickel wire, had an average performance rate of 87.4. Three different performance tests were performed for drill bits produced with an inner layer made from metal mesh. The first group with metal mesh, which had five drill bits with 0.063 mm nickel mesh, had a performance rate of 80.2. The second group with metal mesh, which had five drill bits with 0.09 mm nickel mesh, had a performance rate of 82.4. The third group with metal mesh, which had five drill bits with 0.125 mm nickel mesh, had a performance rate of 91.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A drill bit, comprising:
a central axis;
a tip segment centered on and extending along the central axis, the tip segment comprising:
a cutting end configured to interface with a workpiece;
an attachment end located opposite the cutting end along the central axis, the attachment end defining an attachment surface facing in a direction away from the cutting end along the central axis;
a body extending between the cutting end and the attachment end; and
a cross-sectional area perpendicular to the central axis defined by an outer perimeter of the body;
a shaft extending along the central axis and aligned with the tip segment, the shaft comprising:
a first end coupled to the attachment end of the tip segment; and
a second end opposite the first end along the central axis, the second end configured to be removably coupled to a rotary tool; and
an interface feature located on the attachment surface and positioned between the attachment end of the tip segment and the first end of the shaft, the interface feature comprising an outer surface facing the first end of the shaft;
wherein the attachment surface of the tip segment and the outer surface of the interface feature define an interface surface;
wherein the interface surface has a surface area greater than the cross-sectional area of the tip segment.

2. The drill bit of claim 1, wherein the interface feature and the tip segment are formed from a single, continuous, and contiguous material.

3. The drill bit of claim 2, wherein the tip segment comprises a first material, and the shaft comprises a second material different from the first material, wherein the first material has a greater hardness than the second material.

4. The drill bit of claim 1, wherein the interface feature comprises a first protrusion extending away from the attachment surface towards the first end of the shaft.

5. The drill bit of claim 4, wherein the interface feature further comprises a plurality of second protrusions extending away from the attachment surface towards the first end of the shaft, wherein each second protrusion of the plurality of second protrusions are spaced from the other second protrusions of the plurality of second protrusions along the attachment surface.

6. The drill bit of claim 5, wherein the first protrusion is positioned along the attachment surface such that first protrusion is centered on the central axis, and wherein each second protrusion of the plurality of second protrusions are positioned radially around the first protrusion.

7. The drill bit of claim 4, wherein the interface feature further comprises a second protrusion extending away from the attachment surface towards the first end of the shaft, wherein the first protrusion extends across the attachment surface of the tip segment between a first side of the tip segment to a second side of the tip segment, and wherein the first protrusion intersects the second protrusion.

8. The drill bit of claim 7, wherein the second protrusion extends across the attachment surface of the tip segment between a third side of the tip segment and a fourth side of the tip segment, and wherein the first protrusion and the second protrusion are perpendicular to each other.

9. The drill bit of claim 4, wherein the first protrusion is spaced from the central axis and radially surrounds the central axis.

10. A drill bit, comprising:
a shaft centered on and extending along a central axis, the shaft comprising:
a first end; and
a second end opposite the first end along the central axis, the second end configured to be removably coupled to a rotary tool;
a tip segment centered on and extending along the central axis, the tip segment comprising:
a cutting end configured to engage a workpiece;
an attachment end located opposite the cutting end along the central axis, the attachment end coupled to the first end of the shaft, the attachment end defining an attachment surface facing the first end of the shaft;
a body extending between the cutting end and the attachment end; and
a cross-sectional area perpendicular to the central axis and defined by an outer perimeter of the body; and
an interface feature formed along the attachment surface, the interface feature comprising an outer surface spaced a distance from the attachment surface of the tip segment,
wherein the attachment surface and the outer surface define an interface surface;
wherein the interface surface has a surface area greater than the cross-sectional area of the tip segment.

11. The drill bit of claim 10, wherein the interface feature comprises at least one recessed section extending into the body of the tip segment towards the cutting end of the tip segment, wherein the attachment surface is spaced first distance from the cutting end, and the outer surface is spaced a second distance from the cutting end, and wherein the second distance is less than the first distance.

12. The drill bit of claim 10, wherein the interface feature comprises at least one protrusion extending away from the attachment surface towards the first end of the shaft, wherein the attachment surface is spaced first distance from the cutting end, and the outer surface is spaced a second distance from the cutting end, and wherein the first distance is less than the second distance.

13. The drill bit of claim 10, wherein a diameter of the drill bit is at least ¾ inches.

14. The drill bit of claim 10, wherein the body of the tip segment is a cylinder shape.

15. The drill bit of claim 14, wherein the interface feature comprises a first recessed section and a second recessed section, wherein the first recessed section extends across a diameter of the tip segment, and wherein the first recessed section intersects the second recessed section.

16. The drill bit of claim 10, wherein the interface feature comprises a recessed section, and wherein the recessed section is spaced from the central axis and radially surrounds the central axis.

17. The drill bit of claim 10, wherein the interface feature comprises a plurality of recesses, and wherein each recess of the plurality of recesses are spaced from the other recesses of the plurality of recesses along the attachment surface.

18. A method of forming a drill bit, comprising:
providing a tip segment made from a first material, the tip segment comprising a cutting end configured to interface with a workpiece, an attachment end opposite the cutting end and defining an attachment surface facing away from the cutting end, and an interface feature located on the attachment surface;
aligning the tip segment with a shaft made from a second material different from the first material such that the interface feature is positioned between the attachment end of the tip segment and a first end of the shaft;
placing an inner layer made from a third material different from the first material and the second material between the tip segment and the shaft; and
heating the tip segment, the shaft, and the inner layer to a specific temperature to join the tip segment, the shaft, and the inner layer together.

19. The method of claim 18, wherein the inner layer is a metal wire mesh.

20. The method of claim 18, further comprising the step of positioning the shaft above the tip segment such that the shaft provides a downward force on the tip segment.
